(19) United States
(12) Patent Application Publication
(10) Pub. No.: US 2003/0188701 A1
(43) Pub. Date: Oct. 9, 2003

(54) Internal combustion engine

(76) Inventor: Christopher L. Daniel, Rocklin, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/407,728

(22) Filed: Apr. 3, 2003

Related U.S. Application Data
(60) Provisional application No. 60/370,791, filed on Apr. 6, 2002.

(51) Int. Cl. F02B 75/18

(52) U.S. Cl. 123/56.1

(57) ABSTRACT

An improved internal combustion engine is provided having a plurality of cylinders that are disposed about a crankshaft at an angle substantially parallel to the crankshaft (e.g., to the axis of rotation of the crankshaft), resulting in a substantially constant and optimal power stroke angle. The engine may include eight cylinders and sixteen pistons disposed in a 360 degree pattern every 45 degrees around the crankshaft. The cylinders may be positioned substantially parallel to the crankshaft resulting in a relatively constant and optimal power stroke (e.g., at 90 degrees), thereby producing higher torque and horsepower compared to combustion engines with varying power stroke angles. Each cylinder may have two opposing pistons. Specifically, each cylinder may include two pistons that move in opposite directions during the power stroke, thereby producing a simultaneous thrust at two different points, which is applied to the crankshaft on every power stroke. The dual pistons in each cylinder also control precise movement of all gases throughout each cylinder cycle, thereby improving efficiency. One piston per cylinder can be made to sit “idle,” allowing the opposing piston to import gases for a longer duration, and export virtually the entire cylinder of spent gases in a single cycle. Moreover, this dual-piston design provides for a four-stroke process in a simplified valve-less engine design, thereby combining the advantages of both four-stroke and two-stroke type engines.

### CROSS-REFERENCE TO RELATED APPLICATIONS

This application claims priority to U.S. Provisional Patent Application No. 60/370,791, filed on Apr. 6, 2002, which is fully and completely incorporated herein by reference.

### FIELD OF THE INVENTION

This invention generally relates to internal combustion engines and more particularly, to an internal combustion engine having a crankshaft and a plurality of piston cylinders disposed in a parallel relationship with the crankshaft, and generating a power stroke that transfers energy at a relatively constant and optimized level, effective to produce higher torque and horsepower relative to prior internal combustion engines with varying power stroke angles.

### BACKGROUND OF THE INVENTION

Internal combustion engines are the most common type of drives used in motor vehicles. Internal combustion engines generate power by converting chemical energy in fuel, such as gasoline, into heat, which performs mechanical work. The conversion of chemical energy into heat is performed in a combustion process. One combustion process, known as a four-stroke process, is most commonly used in automotive, reciprocating-piston engines.

A typical reciprocating-piston engine includes a plurality of cylinders, which are disposed at some angle relative to a crankshaft (e.g., in a V-configuration relative to the crankshaft). Each cylinder slidably contains a cylindrical piston, which is rotatably coupled to the crankshaft by way of a connecting rod. Each cylinder further includes one or more intake valves for taking in a fuel-air mixture, a spark plug for igniting the mixture, and one or more exhaust valves for expelling combustion byproducts from the cylinder. In conventional engines, the four-stroke combustion process typically requires a control shaft (e.g., a camshaft) to control the movement of the valves to effectuate the desired gas exchange. During the exhaust phase, the camshaft opens the exhaust valve(s) as the piston moves upward in the cylinder to drive out combustion gases from the cylinder. In the intake phase, which follows the exhaust phase, the camshaft opens the intake valve(s) as the piston moves downward in the cylinder, thereby inducing fresh air into the cylinder, which is combined with fuel (e.g., by way of a fuel injector) to provide a combustible air-fuel mixture. Next, in the compression phase, the piston again moves upward in the cylinder. During the compression phase, the valves are closed, thereby causing the air-fuel mixture to be compressed within the combustion chamber. The spark is activated to ignite the mixture, thereby driving the piston downward in the combustion phase or power stroke. In this manner, the chemical energy of the fuel is converted into heat, which is used to rotatably drive the crankshaft.

The four-stroke process provides very good volumetric efficiency over a broad range of engine speeds. This process further has relatively low sensitivity to pressure losses in the exhaust system, and allows relatively good controllability by use of valve timing strategies. However, when implemented in reciprocating-piston engines, this process suffers from some disadvantages. For instance, the required valve control systems and components are very complex and undesirably increase the cost and complexity and decrease the efficiency of vehicle engines. Furthermore, due to the angular relationship between the pistons and the crankshaft, the power stroke typically starts at a relatively small angle (e.g., approximately 10 degrees) and achieves an optimal angle to transfer torque (e.g., 90 degrees) for only an instant in the power stroke. As a result, the transfer of torque in this process is relatively inefficient.

Some other reciprocating-piston engines utilize a two-stroke combustion process. In a two-stroke process, gas exchange may be achieved without an additional crankshaft rotation by performing the exchange at the end of expansion (e.g., at the end of the power stroke) and at the beginning of the compression stroke. The times at which the intake and exhaust processes occur are usually controlled by the piston, which moves past intake and exhaust ports in the cylinder housing near bottom dead center. Because the two-stroke process lacks separate intake and exhaust strokes, the cylinders must be scavenged using gauge pressure (e.g., by use of scavenging pumps).

The two-stroke process allows for a simplified valve-less engine design, with less weight and low manufacturing costs. However, this process suffers from significant drawbacks that make it undesirable for use in most automotive engines. For example, the two-stroke process results in substantially higher fuel consumption and hydrocarbon emissions (e.g., cylinder scavenging is problematic). Moreover, this process results in higher thermal loading due to the lack of a gas exchange stroke, and poor idle behavior due to a higher percentage of residual gas.

It is therefore desirable to provide a new and improved internal combustion engine that combines the advantages of a four-stroke combustion process with the simplicity of a two-stroke valve-less design, and that generates a power stroke that transfers energy at a relatively constant and optimized angle, effective to produce higher torque and horsepower relative to prior internal combustion engines.

### SUMMARY OF THE INVENTION

The present invention relates to an improved internal combustion engine having a plurality of cylinders that are disposed around a crankshaft at an angle substantially parallel to the crankshaft (e.g., to the axis of rotation of the crankshaft), resulting in a substantially constant and optimal power stroke angle. In one embodiment, the engine includes eight cylinders and sixteen pistons disposed in a 360-degree pattern, with one cylinder located every 45 degrees around the crankshaft. The cylinders are positioned substantially parallel to the crankshaft, resulting in a substantially constant and optimal power stroke (e.g., at about 90 degrees), thereby producing higher torque and horsepower compared to combustion engines with varying power stroke angles. Each cylinder has two opposing pistons. Specifically, each cylinder includes two pistons that move in opposite directions during the power stroke, thereby producing a simultaneous thrust at two different points, which is applied to the crankshaft during every power stroke. This substantially increases the efficiency of power distributed on every power stroke compared to a single piston design. The dual pistons in each cylinder also control precise exchange of all gases throughout each cylinder cycle, thereby improving efficiency. The reason for this is one piston per cylinder can be made to sit “idle,” allowing the opposing piston to import gases for a longer duration, and purge virtually the entire cylinder of spent gases in a single cycle. Moreover, this design provides for a four-stroke process in a simplified valve-less engine design, thereby combining the advantages of both four-stroke and two-stroke type engines.

One non-limiting advantage of the present invention is that it provides an improved internal combustion engine, having increased torque and horsepower relatively to a conventional internal combustion engine of similar size (e.g., displacement).

Another non-limiting advantage of the present invention is that it provides an improved internal combustion engine with increased efficiency and reliability.

Another non-limiting advantage of the present invention is that it provides an improved internal combustion engine, which implements a four-stroke combustion process in a simplified valve-less design.

According to one aspect of the present invention, an internal combustion engine is provided and includes a housing; a crankshaft, which is rotatably disposed within the housing, and which includes at least one groove formed around an outer surface; and a plurality of combustion chambers formed within the housing and disposed around the crankshaft in a substantially parallel relationship to the crankshaft. Each of the combustion chambers includes at least one intake port for receiving a fuel and air mixture into the combustion chamber; at least one exhaust port for expelling exhaust gases from the combustion chamber; at least one piston which slidably moves within the combustion chamber, effective to selectively compress the fuel and air mixture, and which includes a crankshaft engaging portion which engages the at least one groove, effective to rotatably drive the crankshaft; and an ignition device, which extends into the combustion chamber and which selectively generates energy which ignites the compressed air and fuel mixture, effective to forcibly move the piston within the combustion chamber, thereby rotatably driving the crankshaft.

According to another aspect of the present invention, an internal combustion engine is provided. The internal combustion engine includes a housing; a crankshaft, which is rotatably disposed within the housing, and which includes an outer surface having a first and second guide disposed around the outer surface; and a plurality of combustion chambers contained within the housing and disposed around the crankshaft in a substantially parallel relationship to the crankshaft, each combustion chamber including: at least one intake port for receiving a fuel and air mixture into the combustion chamber; at least one exhaust port for expelling exhaust gases from the combustion chamber; and a pair of opposing pistons, which are operatively disposed within the combustion chamber, and comprising an intake side piston that moves within the combustion chamber in a manner effective to selectively open and close the intake port, and an exhaust side piston that moves within the combustion chamber in a manner effective to selectively open and close the exhaust port and which cooperates with the intake side piston to compress the fuel and air mixture and drive the crankshaft. The engine further includes a plurality of connecting pins, each of which is coupled to a unique one of the pistons and which includes a crankshaft engaging portion that engages one of the first and second guides, thereby allowing the piston to rotatably drive the crankshaft; and a plurality of ignition devices, each of which extends into a combustion chamber and selectively generates energy for igniting the compressed air and fuel mixture, effective to forcibly move the pistons within the combustion chambers, thereby rotatably driving the crankshaft.

According to another aspect of the present invention, a crankshaft drive system is provided. The crankshaft drive system includes a crankshaft having an outer surface and a curved groove formed around the outer surface; a piston which is movably disposed in a substantially parallel relationship to the crankshaft; and a member that extends from the piston and which engages and slidably moves within the groove, such that movement of the piston in a reciprocating motion causes the member to move within the groove and rotatably drive the crankshaft.

These and other aspects, features and advantages of the present invention, as well as the invention itself, will be best understood from the following drawings and detailed description.

### BRIEF DESCRIPTION OF THE DRAWINGS

FIG. 1 is a partial cut-away view of a preferred embodiment of an internal combustion engine, according to the present invention.

FIG. 2 is a sectional view of the engine shown in FIG. 1, illustrating a power stroke and an exhaust stroke.

FIG. 3 is a sectional view of the engine shown in FIG. 1, illustrating an intake stroke and a compression stroke.

FIG. 4 is a 360-degree schematic, flat pattern layout of a crankshaft for use in the engine of FIG. 1, illustrating the crankshaft groove and the timing sequence of a pair of pistons.

FIGS. 5A and 5B are front and side views, respectively, of an embodiment of an intake housing of the engine shown in FIG. 1.

FIGS. 6A and 6B are front and side views, respectively, of an embodiment of a center housing of the engine shown in FIG. 1.

FIGS. 7A and 7B are front and side views, respectively, of an embodiment of an exhaust housing of the engine shown in FIG. 1.

FIG. 8 is a front view of an embodiment of a piston sleeve for use in the engine shown in FIG. 1.

FIG. 9 is a front view of an embodiment of a crankshaft for use in the engine shown in FIG. 1.

FIG. 10 is a front view of an embodiment of an exhaust end cap of the engine shown in FIG. 1.

FIG. 11 is a front view of an embodiment of an intake end cap of the engine shown in FIG. 1.

FIG. 12 is a front view of an embodiment of a throttle plate for use in the engine shown in FIG. 1.

FIG. 13 is a front view of an embodiment of a throttle ring for use in the engine shown in FIG. 1.

FIGS. 14A and 14B are front views of exemplary embodiments of an intake and exhaust turbine for use in the engine shown in FIG. 1, respectively.

FIG. 15 is a side view of an embodiment of a piston of the engine shown in FIG. 1.

FIG. 16 illustrates an embodiment of a timing assembly, according to the present invention.

FIG. 17 is a perspective view of the entire engine, according to the present invention.

### DETAILED DESCRIPTION OF THE EMBODIMENTS

The present invention will now be described in detail with reference to the drawings, which are provided as illustrative examples of the invention so as to enable those skilled in the art to practice the invention. Preferred embodiments of the present invention are illustrated in the Figures, like numerals being used to refer to like and corresponding parts of various drawings. Where certain elements of the present invention can be partially or fully implemented using known components, only those portions of such known components that are necessary for an understanding of the present invention will be described, and detailed descriptions of other portions of such known components will be omitted so as not to obscure the invention.

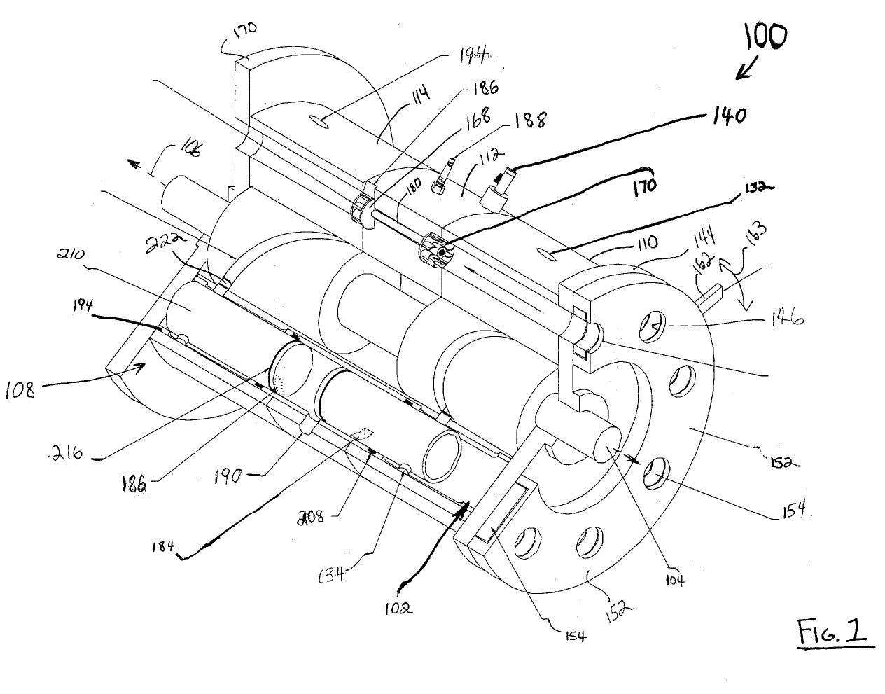

Referring now to FIG. 1, there is shown a preferred embodiment of an internal combustion engine 100, according to the present invention. In the preferred embodiment, engine 100 includes eight substantially identical combustion chambers or cylinders 102, which are disposed in a generally circular pattern around a crankshaft 104. While the following discussion relates to an eight cylinder engine, it should be appreciated that the novel engine design and architecture of the present invention may be implemented with any other number of cylinders, and that the resulting engine may be of any desirable size and adapted for use in any application. Each of cylinders 102 is disposed substantially parallel to one another and to crankshaft 104 (e.g., to the axis of rotation 106 of crankshaft 104). The engine 100 includes a generally cylindrical, three-part housing 108, including an intake housing 110, a center housing 112, and an exhaust housing 114, which may be coupled together in a conventional manner (e.g., by use of conventional fasteners or bolts (not shown)). Housings 110-114 are preferably made from a commercially available, durable material such as aluminum, steel, and/or a composite material. In alternate embodiments, housing 108 can be formed from different (e.g., fewer or greater) numbers of individual housing portions.

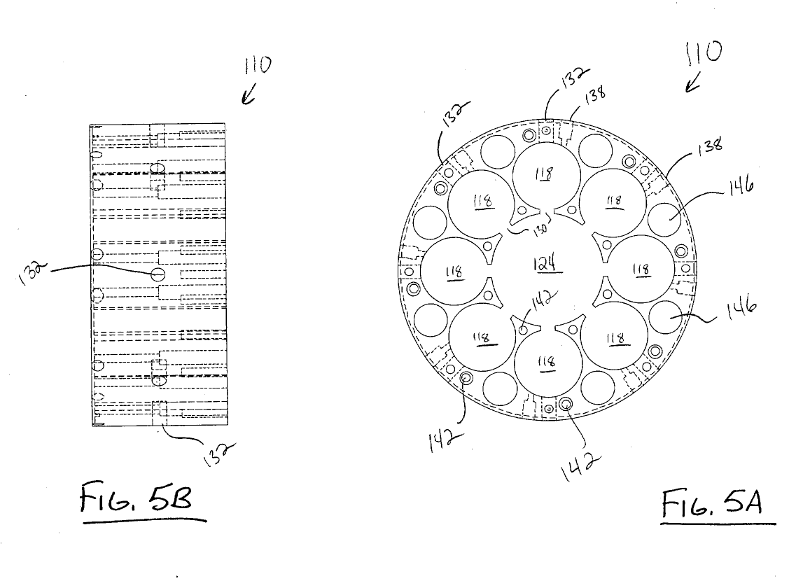

FIGS. 5A-B, 6A-B and 7A-B respectively illustrate housings 110, 112, and 114 in greater detail. Housings 110,112 and 114 each include eight generally cylindrical channels 118, 120 and 122, respectively, which cooperatively form cylinders 102. Housings 110, 112 and 114 each further include a generally cylindrical central channel, 124, 126 and 128, respectively, which cooperatively house crankshaft 104. Intake housing 110 includes eight slots 130, each of which extends between one of channels 118 and central channel 124. Each slot 130 receives a piston pin or member 134, which is slidably disposed within the slot 130. Intake housing 110 further includes eight piston pin access holes 132, each of which communicates with a channel 118. Piston pin access holes 132 allow piston pins 134 to be inserted (e.g., press fitted) into pistons 210 after housing 108 is assembled. Intake housing 110 further includes eight air intake ports 146 for communicating outside air into the combustion chambers 102. In one embodiment, intake housing 110 may include eight fuel injector reception holes 138, each of which communicates with a channel 118 and is adapted to receive a fuel injector 140 for injecting fuel into the combustion chamber. However, in the preferred embodiment, fuel injector receptions holes 138 are located in central housing 112 (as shown in FIG. 1). Furthermore, in alternate embodiments, engine 100 may be carbureted, and housing 108 may accordingly contain reception holes for receiving fuel from a conventional carburetor. Intake housing 110 may also include several apertures 142, which are adapted to receive conventional fasteners or bolts (not shown) for connecting the intake housing 110 to the central housing 112, and for connecting an intake end cap 144 to intake housing 110.

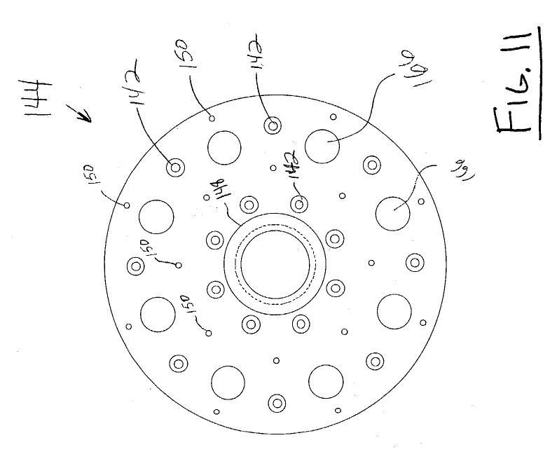

FIG. 11 illustrates an intake end cap 144. End cap 144 includes a central hub 148, which is adapted to receive an end of crankshaft 104. Hub 148 may include a bearing that engages the end of crankshaft 104, thereby facilitating rotation of the crankshaft 104. End cap 144 further includes eight apertures 158, which are aligned with intake ports 146 and allow air to enter the ports 146. End cap 144 may further include several apertures 142, which are adapted to receive conventional fasteners or bolts (not shown) for connecting the end cap 144 to the intake housing 110, and several apertures 150, which are adapted to receive conventional fasteners or bolts (not shown) for connecting a throttle plate 152 to end cap 144.

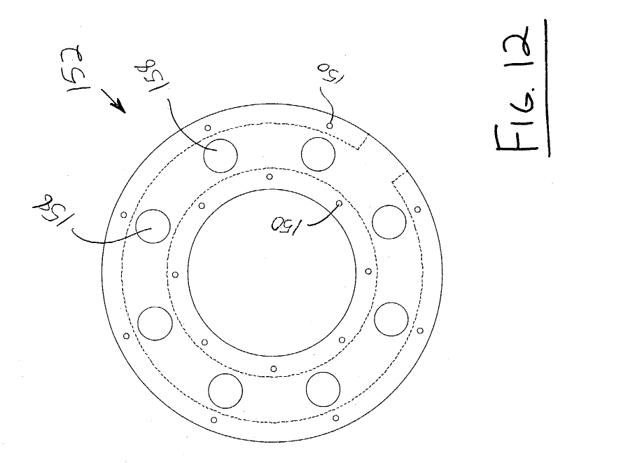

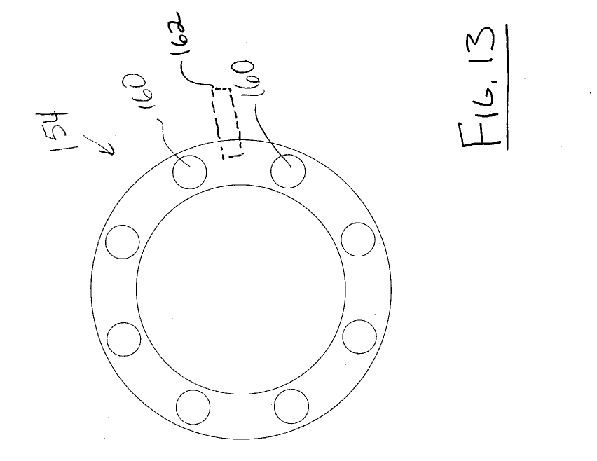

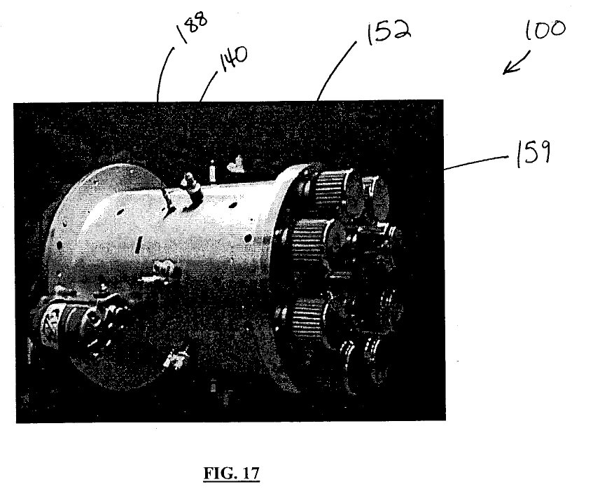

FIG. 12 illustrates a throttle plate 152, and FIG. 13 illustrates a throttle ring 154. Throttle plate 152 is generally ring shaped and includes a hollow inner channel in which throttle ring 154 is rotatably disposed. Throttle plate 152 includes eight apertures 158, which are aligned with intake passages 146 and end cap apertures 166. Each of apertures 158 may be adapted to receive a conventional air filter 159, as shown in FIG. 17, for preventing dust and other particles from entering the combustion chambers. Throttle ring 154 also includes eight apertures 160, which may be selectively aligned with and misaligned from apertures 158 by rotating throttle ring lever 162 in the directions of arrows 163 (see FIG. 1). In this manner, the throttle plate 152, ring 154 and lever 162 may be used to control air intake (and thus the speed of the engine) by selectively opening and closing access to intake passages 146. Throttle lever 162 may be attached to ring 154 in any conventional manner (e.g., by use of conventional bonding maternal or fasteners). Throttle lever 162 may also be communicatively connected to the vehicle accelerator or throttle system in a conventional manner (e.g., by way of a mechanical connection or an electromechanical actuator). Throttle plate 152 may also include several apertures 150, which are adapted to receive conventional fasteners or bolts (not shown) for connecting the throttle plate to the end cap 144. In one embodiment, throttle plate 152 and ring 154 may be incorporated within end cap 144.

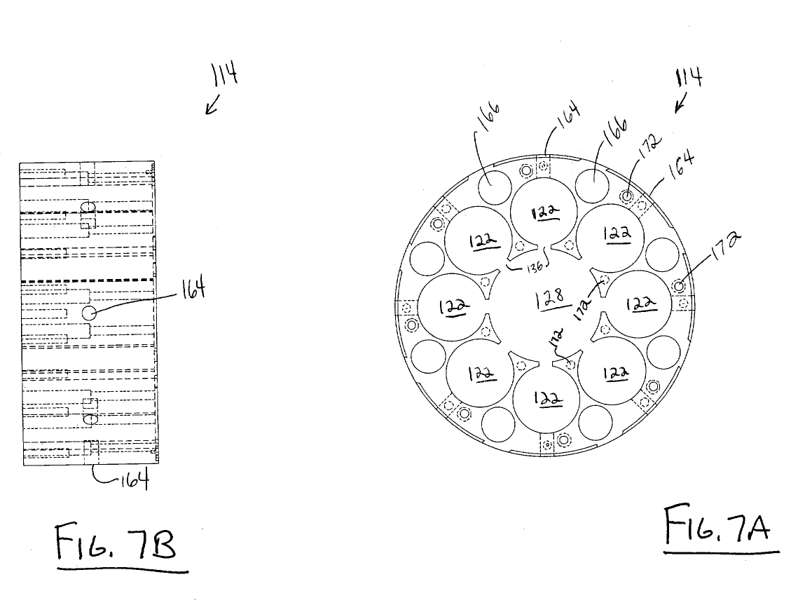

Referring back to FIGS. 7A-B, exhaust housing 114 includes eight slots 136, each of which extends between one of channels 122 and central channel 128. Each slot 136 receives a piston pin 134, which is slidably disposed within the slot 136. Exhaust housing 114 further includes eight piston pin access holes 164, each of which communicates with a channel 122. Piston pin access holes 164 allow piston pins 134 to be inserted (e.g., press fitted) into pistons 134 after housing 108 is assembled. Exhaust housing 114 further includes eight access ports 166, which allow access to exhaust turbines 168 (shown in FIG. 1). When the housing 108 is fully assembled, exhaust turbines 168 may partially extend within ports 166. Exhaust housing 114 may also include several apertures 172, which are adapted to receive conventional fasteners or bolts (not shown) for connecting the exhaust housing 114 to the central housing 112, and for connecting an exhaust end cap 170 to exhaust housing 114.

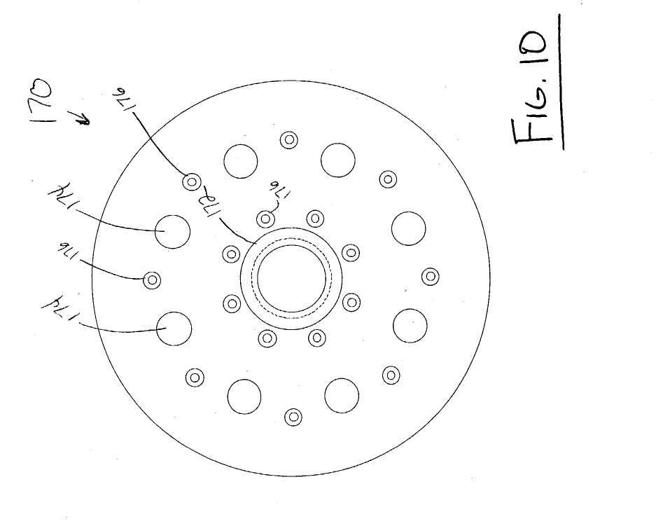

FIG. 10 illustrates an exhaust end cap 170. End cap 170 includes a central hub 172, which is adapted to receive an end of crankshaft 104. Hub 172 may include a bearing that engages the end of crankshaft 104, thereby facilitating rotation of the crankshaft 104. In the preferred embodiment, the exhaust end of the crankshaft is threaded, thereby allowing for attachment of conventional components, such as a flywheel and/or timing assembly, and for attachment to a vehicle's drive train. End cap 170 includes eight apertures 174, which are aligned with access ports 166 for allowing access to exhaust turbines 168. End cap 170 may further include several apertures 176, which are adapted to receive conventional fasteners or bolts (not shown) for connecting the end cap 170 to the exhaust housing 114.

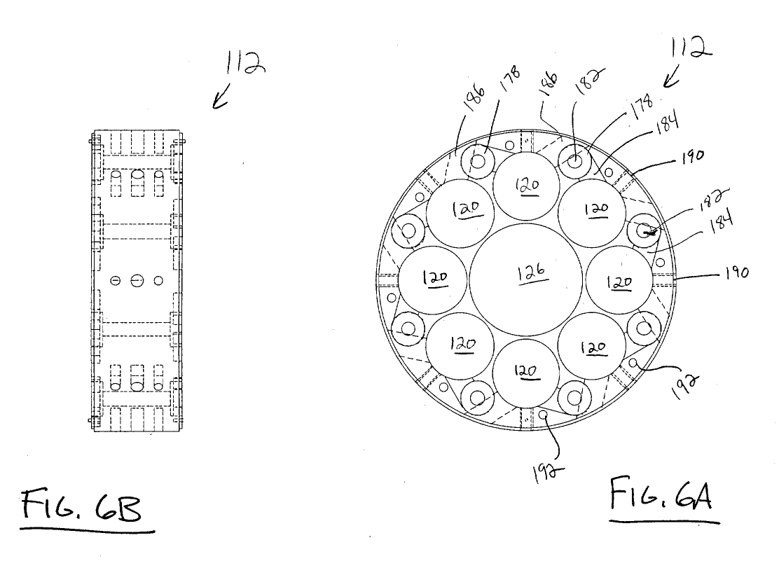

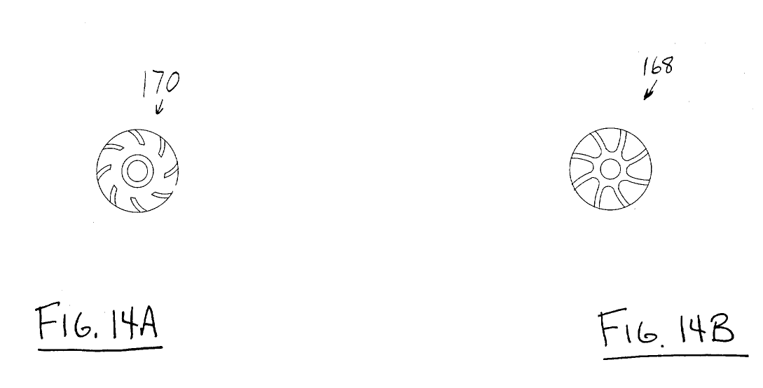

Referring back to FIGS. 6A-B, center housing 112 includes eight channels 178, which communicate with intake passages 146 and which are shaped to house intake blowers 170 (on the intake side of the housing) and exhaust turbines 168 (on the exhaust side of the housing). As shown best in FIG. 1, a conventional intake blower 170 and exhaust turbine 168 are disposed at the end of each of the channels 178. FIGS. 14A and 14B illustrate exemplary embodiments of an intake blower 170 and an exhaust turbine 168, respectively. Each blower 170 and turbine 168 pair are connected together by a rod 180. The rod 180 is sealably and rotatably contained within a narrow portion 182 of channel 178, and prevents air and/or fuel from passing from the intake or blower side of the channel 178 to the exhaust or turbine side of the channel 178. The intake side of each channel 182 includes an intake port 184, which communicates with a corresponding channel 120, thereby allowing air and fuel to be communicated to the associated combustion cylinder 102. In the preferred embodiment of the invention, each fuel injector 140 is disposed directly above the intake port 184, thereby allowing the air/fuel mixture to be injected directly into the combustion chamber 102. In other embodiments, the fuel injectors 140 may be disposed within the intake housing, thereby creating an air/fuel mixture prior to entry into the blower region. The exhaust side of each channel 178 includes an exhaust port 186, which communicates with channel 120 and with the exterior of the engine 100. Exhaust ports 186 allow exhaust gasses to be expelled from the combustion chambers 102. Exhaust ports 186 may be communicatively coupled to a vehicle exhaust system in a conventional manner (e.g., by way of one or more conduits). As shown in FIG. 6A, the exhaust port 186 and intake port 184 of each channel 182 communicate with adjacent cylinders. In this manner, the exhaust gases from one cylinder drive the exhaust turbine 168 and intake blower 170 for the next (i.e., adjacent) cylinder, thereby driving air into that cylinder. While the preferred embodiment illustrates one intake and one exhaust port per cylinder, alternate embodiments may include any number of intake and exhaust ports per cylinder. Furthermore, as discussed below in reference to the operation of engine 100, the location of the intake and exhaust ports and the movement of the pistons of engine 100 obviate the need for valves, thereby greatly simplifying the design of engine 100. However, in alternate embodiments, valves (e.g., cam-driven or electromechanically actuated valves) may be employed for opening and closing the intake and exhaust ports.

Central housing 112 further includes eight spark plug holes 190, each of which communicates with a channel 120, and is adapted to receive a conventional sparkplug 188 (see FIG. 1). In alternate embodiments (e.g., in diesel embodiments), sparkplugs 188 may be replaced with other types of ignition devices, such as glow plugs or the like. Central housing 112 may also include one or more interior channels (not shown) extending around the inner and/or outer peripheries of the housing, and/or between the cylinders 102. These channels may receive cooling fluid (e.g., by fluidly coupling the channels to a conventional heat exchanger), thereby removing heat from engine 100. Central housing 112 may also include several apertures 192, which are adapted to receive conventional fasteners or bolts (not shown) for connecting the central housing 112 to the intake and exhaust housings 110, 114.

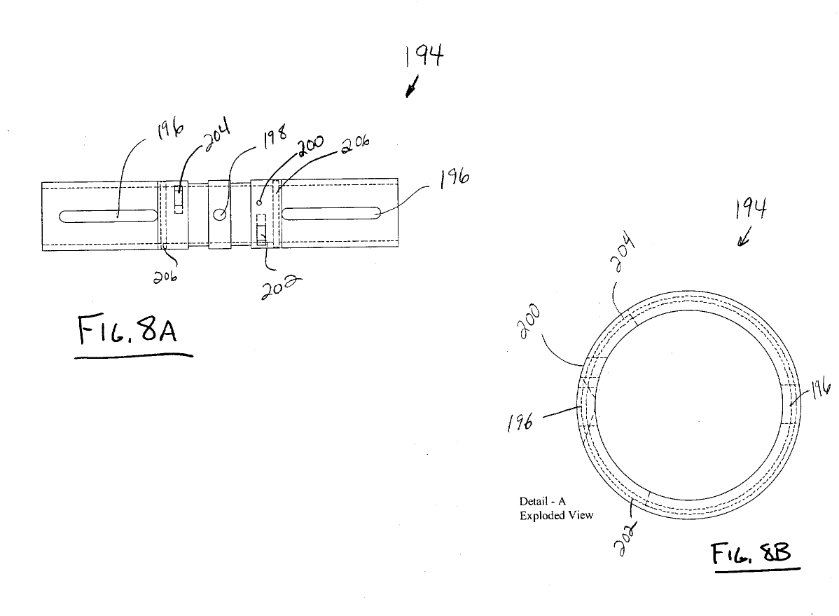

FIGS. 8A and 8B illustrate an embodiment of a cylinder sleeve 194 for use in engine 100. Sleeve 194 is preferably formed from a relatively durable, hard and temperature resistant material, such as hardened steel. The engine may include eight cylinder sleeves 194, which are generally cylindrical in shape and which are adapted to be pressed into the channels 118-122 in order to form the combustion chambers 102. Each cylinder sleeve 194 includes two pairs of opposing slots or piston pin guides 196, which are shaped to receive a piston pin 134, which is slidably contained within the slots 196. Piston pins 134 may also include conventional bearings (not shown) for engaging guides 196, thereby facilitating the sliding motion of the piston pins 134 within the guides 196. Each cylinder sleeve 194 further includes a spark opening 198, which communicates with the combustions chamber and receives the tip of a sparkplug 188, thereby allowing the sparkplug 188 to ignite the compressed air/fuel mixture within the combustion chamber. A fuel injection aperture 200 receives fuel from the fuel injector 140, thereby allowing the fuel to be communicated into the combustion chamber. Each cylinder sleeve 194 further includes slots 202 and 204, which correspond to and communicate with the combustion chamber's intake and output ports 184, 186, respectively. Each cylinder sleeve 194 may further include a pair of generally circular grooves 206 on its interior,surface. As shown, each groove 206 is disposed between the intake/exhaust slot 202/204, and the slot 196. The grooves 206 are adapted to receive a piston seal 208 (see FIG. 1). Piston seals 208 engage the outer surface of the pistons 210, thereby sealing the respective sides of the combustion chambers 102.

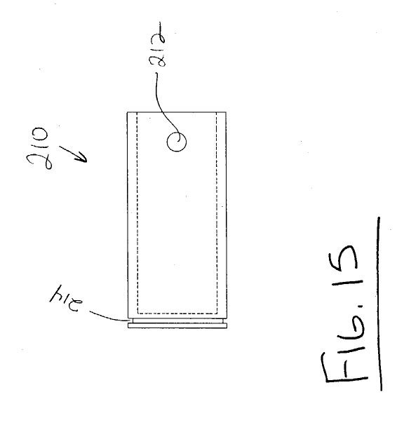

FIG. 15 illustrates an embodiment of a piston 210 for use within the engine 100. Piston 210 and pin 134 are preferably formed from a relatively durable, hard and temperature resistant material, such as hardened steel. Each cylinder 102 includes a pair of opposing pistons 210. Each piston 210 may be hollow and generally cylindrical in shape, and may include a pair of opposing apertures 212, which are adapted to receive a piston pin 134 in a press-fit engagement. Piston 210 and pin 134 may further include locking bolts or other conventional securing mechanisms (not shown) for securely fixing the pin 134 to the piston 210. Each piston 210 may include a circular groove 214 formed in its outer surface, near the front of the piston. As shown in FIG. 1, groove 214 is adapted to receive and contain a conventional piston ring 216, which engages the inner surface of the combustion chamber 102 (e.g., of the cylinder sleeve 194). Each piston 210 is opposed to another piston 210 within each combustion chamber 102 and slides freely within the combustion chamber 102. The piston pin 134 is inserted through the piston pin guide 196, allowing the piston 210 to glide back and forth in the piston cylinder only to the extent of the piston pin guide 196.

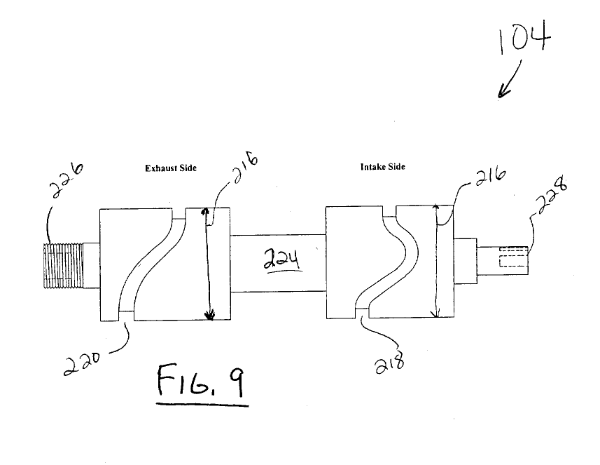

FIG. 9 illustrates an embodiment of a crankshaft 104 for use within engine 100. Crankshaft 104 is preferably formed from a relatively durable, hard and temperature resistant material, such as hardened steel. Unlike conventional crankshafts, crankshaft 104 has a relatively large diameter 216, which is rotatably driven by the pistons 210. Pistons 104 are not coupled to the crankshaft 210 by connecting rods (as in prior engines). Rather the pistons 210 engage and rotatably drive the crankshaft 104 by pins 134, which move within grooves 218 and 220 that are formed on the outer surface of the crankshaft 104. Intake groove 218 and exhaust groove 220 are 360-degree precision cuts that form curved paths around the outer surface of the crankshaft 104. The engagement between pins 134 and grooves 218, 220 allow the combustion cylinders 102 and pistons 210 to be disposed in a substantially parallel relationship with the crankshaft 104 (e.g., with the axis of rotation 106 of the crankshaft 104). As discussed more fully and completely below, the shape of grooves 218 and 220 respectively control the actuation sequence and movement of the intake and exhaust side pistons 210. In the preferred embodiment, the end of each pin 134, which engages groove 218/220, includes a conventional bearing 222, which facilitates the sliding movement of the pin 134 within the groove 218/220. The combination of the unique crankshaft design and piston arrangement provides for a novel crankshaft drive system in which reciprocating movement of the pistons, relatively parallel to the crankshaft, rotatably drives the crankshaft at a relatively constant and optimal angle.

In one embodiment, crankshaft 104 may have a narrowed central portion 224 that reduces overall weight. Crankshaft 104 includes a threaded exhaust end 226. End 226 may be used to attach components, such as a flywheel and timing ring in a conventional manner (e.g., by threading, bolting or otherwise fastening the components to end 226), and for connection to a vehicle's drive train, thereby allowing the engine to provide power to the drive train. Crankshaft 104 further includes a splined intake end 228, on which various accessories may be coupled.

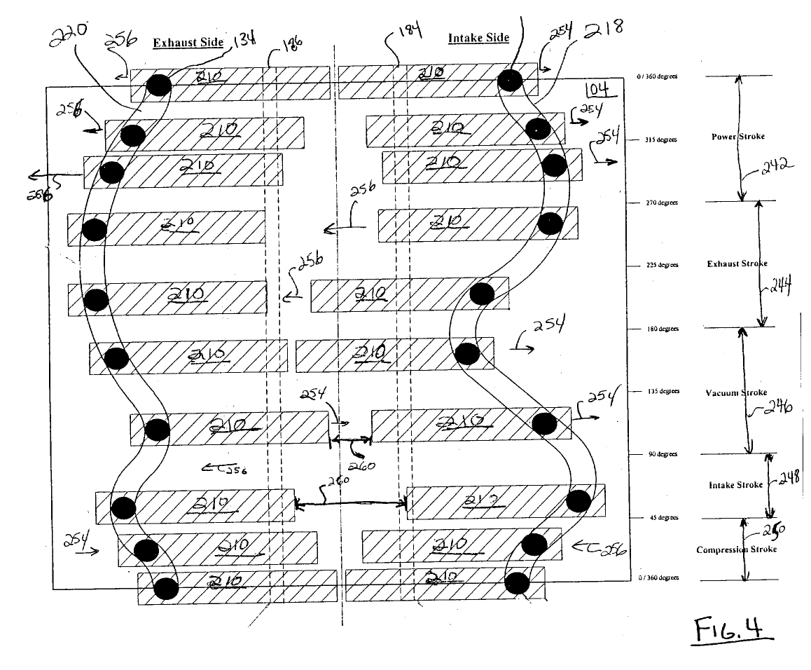

The crankshaft 104 is surrounded by the eight cylinders 102, which are spaced out at every 45 degrees around the center of the crankshaft 104. FIG. 4 is a flat 360 degree view of the crankshaft 104, illustrating the precision cut guides or grooves 218 and 220. Each guide 218, 220 is laid-out in a precise pattern in order to allow the pistons 210 to maintain precise movement in the combustion cylinders 102 (e.g., shown by the relative positions of the opposing pistons 210 shown in FIG. 4). Eight piston pins 134 glide in the intake groove 218, and eight piston pins 134 glide in the exhaust groove 220.

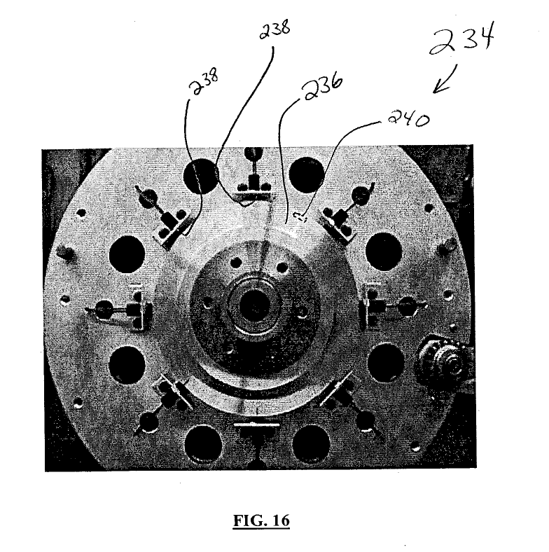

FIG. 16 illustrates one embodiment of a timing assembly 234 that may be used to detect the position of crankshaft 104 and time the firing of sparkplugs 188. As shown, timing assembly 234 includes a timing ring 236 which may be coupled to an end (e.g., end 226) of crankshaft 104 in a conventional manner, and plurality of sensors 238 which are disposed in a ring concentric to cylinders 102. In the preferred embodiment, each sensor 238 is adjacent to and corresponds with a unique one of cylinders 102. Timing ring 236 may include a magnet 240 disposed on the outer periphery of ring 236. As ring 236 rotates, the magnet 240 may be detected by each sensor 238, as it passes adjacent to the sensor 238, thereby allowing for crankshaft rotational position sensing and ignition timing. For example, in one embodiment, the timing ring 236 and sensors 238 are arranged such that as the magnet 240 passes each sensor 238, the sensor 238 generates an ignition timing signal, which coincides with the completion of a compression phase in one of cylinders 102. This ignition timing signal may be communicated to a sparkplug 188 corresponding to that cylinder, thereby causing the sparkplug 188 to generate a spark and ignite the compressed air/fuel mixture. It should be appreciated that the signals generated by sensors 238 may be further processed in conventional manner and used to delay, advance and/or otherwise control the ignition timing of the engine, according to achieve a desired performance objective.

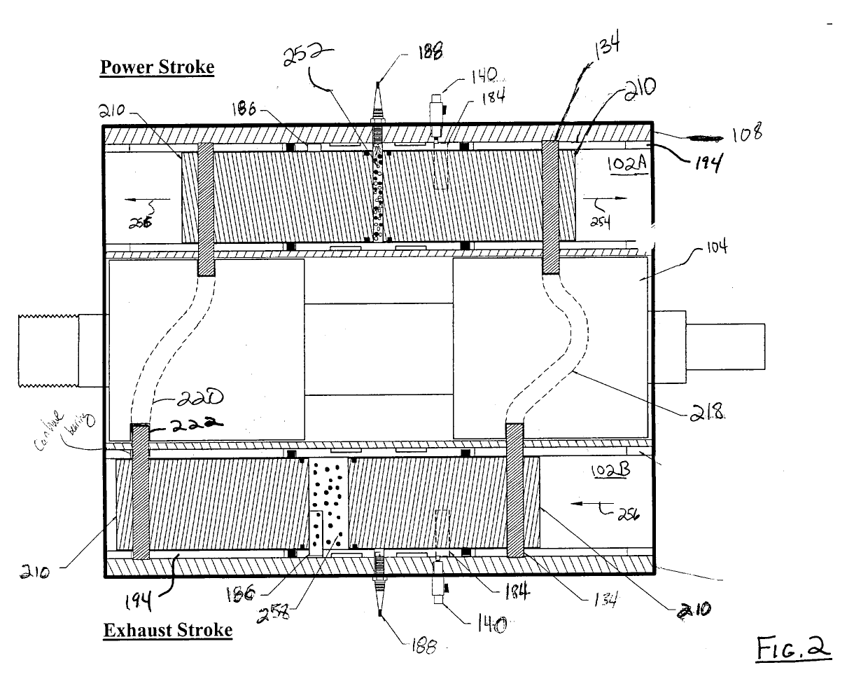

The operation of engine 100 is best described with reference to FIGS. 2, 3 and 4, which illustrate the combustion phases and timing sequence of the preferred embodiment. FIG. 4 illustrates the relative position of a pair of opposing pistons as the pistons move along the piston pin guides 218 and 220 of the crankshaft 104. This figure is intended to illustrate one exemplary firing sequence that may be employed and the movement of a pair of opposing pistons 210 as they move through the complete firing sequence, starting and ending at a 0/360 degree point on the crankshaft. It should be appreciated that the pistons 210 in each cylinder 102 will consecutively undergo the same movement (i.e., adjacent cylinders will fire in succession). As shown, the shape of grooves 218 and 220 will control the movement and position of pistons 210 throughout the timing sequence. The shape of grooves 218 and 220 may be modified to alter the movements of the pistons 210 during the firing sequence, in order to achieve different performance. Those skilled in the art will understand how to adjust the shape of the grooves 218, 220 in order to achieve desired performance characteristics (e.g., different piston movements).

As shown, the timing sequence may begin with a power stroke 242. The start of the power stroke is shown best in the top cylinder 102A of FIG. 2. The power stroke begins when the pistons 210 are in a central compressed position, thereby creating a compressed air/fuel mixture 252. The sparkplug 188 ignites the compressed air/fuel mixture, causing an explosion that produces pressure that forces the pistons to move in opposite directions as shown by arrows 254 and 256. The piston pins 134 follow the guides 196, and the ends of the pins 134 ride in grooves 218, 220, thereby forcing the crankshaft 104 to rotate about its axis 106. The exhaust stroke 244 follows the intake stroke 242.

The exhaust stroke 244 begins when the exhaust side piston 210 moves into a fully retracted position, thereby opening or exposing exhaust port 186. (It should be noted that during the power and exhaust strokes the intake side piston does not retract beyond intake port 184, thereby preventing any exhaust gases from being discharged from the intake port 184.) The exhaust side piston remains fully and/or partially retracted through the exhaust stroke 244, such that the exhaust port 186 remains open for the discharge of exhaust gases. While the exhaust side piston maintains this position, the intake side piston moves toward the exhaust side piston in the direction of arrows 256. This reduces the volume of the combustion chamber and forces the exhaust gases 258 out of the exhaust port 186, as shown in the bottom cylinder 102B of FIG. 2. Exhaust turbine 168 assists in this discharge process.

After the exhaust gases 258 are discharged, the pistons 210 begin to move back together in the directions of arrows 254. As shown in FIG. 4, the intake side piston moves back at a faster rate than the exhaust piston, thereby creating a volumetric gap 260 between the pistons. This gap creates a vacuum condition within combustion chamber 102. During this “vacuum stroke” 246, the exhaust side piston 210 also changes direction begins to retract in the direction of arrow 256, thereby further increasing the volumetric gap 260 and thus the vacuum condition in the combustion chamber 102.

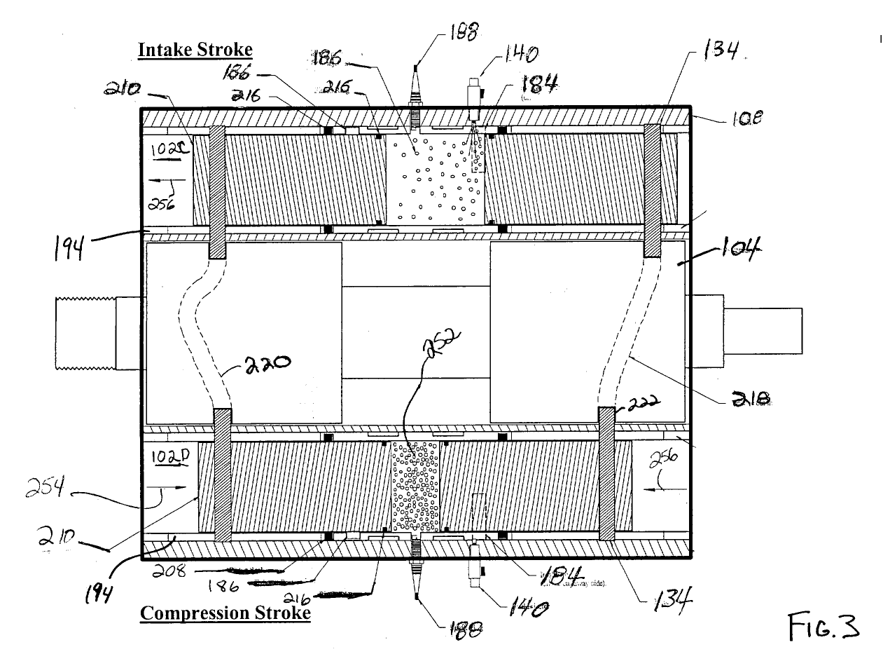

The intake stroke 248 begins as the intake side piston passes beyond intake port 184, thereby opening the port 184 and allowing air and fuel to be sucked into the combustion chamber. The exhaust side piston continues to retract in the direction of arrow 256, thereby further drawing air into the cylinder. Blower 170 will further assist in this air intake process. As air is being drawn in, the fuel injector 140 injects fuel into the cylinder that mixes with the air to create an air/fuel mixture 262, as shown in the top cylinder 102C of FIG. 3.

In the compression stroke 250, which follows the intake stroke 248, the pistons move together in the directions of arrows 254 and 256, thereby creating a compressed air/fuel mixture 252, as shown in the bottom cylinder 102D of FIG. 3. Once the compressed air/fuel mixture 252 reaches maximum compression (e.g., when the intake and exhaust side pistons are closest together), the sparkplug 188 ignites the mixture, thereby restarting the timing sequence.

As the first cylinder fires (e.g., ignition from sparkplug), the generated pressure forces the pistons to move apart in opposite directions, rotating the crankshaft to the second adjacent cylinder's firing position. The second cylinder then fires and forces the crankshaft to move to a third cylinder's firing position; the fourth, fifth, sixth, seventh and eighth cylinders fire in a substantially similar and consecutive manner. The firing sequence begins again with the first cylinder. As each cylinder fires, every other cylinder will be in a different part of the timing sequence, based upon its position on the crankshaft. Each sparkplug 188 is preferably ignited when the air/fuel mixture is in a most compressed state. However, timing of the spark can be adjusted in a conventional manner to achieve different performance.

In this manner, the present invention provides a novel internal combustion engine, which produces high horsepower and torque and which is compact in size. The unique crankshaft drive system provided by the present invention (e.g., the design of the pistons, piston cylinders, and crankshaft) allows the pistons to drive the crankshaft at a relatively constant and optimal angle (e.g., 90 degrees). In the preferred embodiment, this is achieved by a 360-degree design having eight cylinders 102 formed in the engine housing 108 at every 45 degrees around the crankshaft 104.

As described in the foregoing discussion, each cylinder preferably has two pistons opposing each other. This substantially increases the efficient of power distributed on every power stroke per cylinder compared to a single piston design. The dual pistons in each cylinder also control precise movement of all gases throughout each cylinder cycle, thereby improving efficiency. The reason for this is one piston per cylinder can be made to sit “idle,” allowing the opposing piston to import gases for a longer duration, and export virtually the entire cylinder of spent gases in a single cycle. Moreover, this arrangement provides for a four-stroke process in a simplified valve-less engine design, thereby combining the advantages of both four-stroke and two-stroke type engines.

In alternate embodiments, a single piston may be contained in each cylinder 102. Such “single piston” embodiments may be similar in design to engine 100, with the exception of the exhaust side of the housing. For example, as will be appreciated to those skilled in the art, the exhaust side piston of each cylinder may be replaced by a static cylinder head, against which the intake piston would compress the air/fuel mixture. The location of the intake and exhaust ports may further be relocated in such a design, and conventional valves (e.g., cam driven or electromechanically actuated) may be used for opening and closing the intake ports in a manner known in the art. Alternatively, the piston movement (e.g., the shape of the groove 218) and intake/exhaust port location may be arranged in a single piston design to provide for a two-stroke combustion process, as will be appreciated to those skilled in the art.

Additionally, as will be appreciated by those skilled in the art the engine of the present invention can be manufactured in any suitable and desirable size, and may be adapted to run with any conventional type of fuel.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

what is claimed is:

1. An internal combustion engine comprising:
a housing;
a crankshaft, which is rotatably disposed within the housing, and which includes at least one groove formed around an outer surface; and
a plurality of combustion chambers formed within the housing and disposed around the crankshaft in a substantially parallel relationship to the crankshaft, each combustion chamber including:
at least one intake port for receiving a fuel and air mixture into the combustion chamber;
at least one exhaust port for expelling exhaust gases from the combustion chamber;
at least one piston which slidably moves within the combustion chamber, effective to selectively compress the fuel and air mixture, and which includes a crankshaft engaging portion which engages the at least one groove, effective to rotatably drive the crankshaft; and
at least one ignition device, which extends into the combustion chamber and which selectively generates energy which ignites the compressed air and fuel mixture, effective to forcibly move the piston within the combustion chamber, thereby rotatably driving the crankshaft.

2. The internal combustion engine of claim 1 wherein the plurality of combustion chambers comprises eight combustion chambers.

3. The internal combustion engine of claim 1 wherein the at least one piston comprises a pair of opposing pistons, including:
an intake side piston which moves back and forth within the combustion chamber, effective to selectively open and close the intake port, compress the air and fuel mixture, and drive the crankshaft; and
an exhaust side piston which moves back and forth within the combustion chamber, effective to selectively open and close the exhaust port, compress the air and fuel mixture, and drive the crankshaft.

4. The internal combustion engine of claim 1 further comprising:
a plurality of fuel injectors which are coupled to the housing and which inject fuel into the engine, which is combined with air and communicated to the combustion chambers.

5. The internal combustion engine of claim 1 further comprising:
a plurality of blowers which communicate with the intake ports and which assist in forcing air into the combustion chambers.

6. The internal combustion engine of claim 1 further comprising:
a plurality of turbines which communicate with the exhaust ports and which assist in expelling exhaust gases from the combustion chambers.

7. The internal combustion engine of claim 1, wherein the housing includes a plurality of air intake passages which communicate with and provide air to the intake ports.

8. The internal combustion engine of claim 7 further comprising:
a throttle plate which is coupled to the housing and which selectively covers and uncovers the air intake passages, effective to control the transfer of air to the combustion chambers.

9. The internal combustion engine of claim 1 wherein the combustion chambers are formed by sleeves which are disposed within the housing.

10. The internal combustion engine of claim 1 further comprising a timing ring assembly which is coupled to an end of the crankshaft and which is adapted to generate signals in response to crankshaft rotation for controlling the ignition devices.

11. The internal combustion engine of claim 1 wherein the ignition devices comprise sparkplugs.

12. The internal combustion engine of claim 1 wherein the ignition devices comprise glow plugs.

13. An internal combustion engine comprising:
a housing;
a crankshaft, which is rotatably disposed within the housing, and which includes an outer surface having a first and second guide disposed around the outer surface;
a plurality of combustion chambers contained within the housing and disposed around the crankshaft in a substantially parallel relationship to the crankshaft, each combustion chamber including:
at least one intake port for receiving a fuel and air mixture into the combustion chamber;
at least one exhaust port for expelling exhaust gases from the combustion chamber; and
a pair of opposing pistons, which are operatively disposed within the combustion chamber, and comprising an intake side piston that moves within the combustion chamber in a manner effective to selectively open and close the intake port, and an exhaust side piston that moves within the combustion chamber in a manner effective to selectively open and close the exhaust port and which cooperates with the intake side piston to compress the fuel and air mixture and drive the crankshaft;
a plurality of connecting pins, each of which is coupled to a unique one of the pistons and which includes a crankshaft engaging portion that engages one of the first and second guides, thereby allowing the piston to rotatably drive the crankshaft; and
a plurality of ignition devices, each of which extends into a combustion chamber and selectively generates energy for igniting the compressed air and fuel mixture, effective to forcibly move the pistons within the combustion chambers, thereby rotatably driving the crankshaft.

14. The internal combustion engine of claim 13 wherein the plurality of combustion chambers comprises eight combustion chambers.

15. The internal combustion engine of claim 13 further comprising:
a plurality of fuel injectors which are coupled to the housing and which inject fuel into the engine, which is combined with air arid communicated to the combustion chambers.

16. The internal combustion engine of claim 13 further comprising:
a plurality of blowers, each of which communicates with a unique one of the intake ports to assist in forcing air into the combustion chambers; and
a plurality of turbines each of which is coupled to a unique one of the plurality of blowers, and communicates with the exhaust ports to assist in expelling exhaust gases from the combustion chambers.

17. The internal combustion engine of claim 13 further comprising:
a plurality of air intake passages which are formed within the housing and which communicate with and provide air to the intake ports;
a throttle plate which is coupled to the housing and which selectively opens and closes the plurality air intake passages, effective to control the transfer of air to the combustion chambers; and
a plurality of air filters which are connected to the throttle plate and which cover the plurality of air intake passages, thereby filtering air which enters into the air intake passages.

18. An crankshaft drive system, comprising:
a crankshaft having an outer surface and a curved groove formed around the outer surface;
a piston which is movably disposed in a substantially parallel relationship to the crankshaft; and
a member that extends from the piston and which engages and slidably moves within the groove, such that movement of the piston in a reciprocating motion causes the member to move within the groove and rotatably drive the crankshaft.

19. The crankshaft drive system of claim 18 further comprising:
a bearing which is coupled to the end and which facilitates sliding movement of the end within the groove.

20. The crankshaft drive system of claim 18 further comprising:
a combustion cylinder in which the piston is movably disposed, the combustion cylinder providing a combustion process for moving the piston in a reciprocating motion.

21. The crankshaft drive system of claim 18 wherein the member comprises a pin which is coupled to the piston.

22. The crankshaft drive system of claim 18 wherein the crankshaft includes a second curved groove formed around the outer surface, and further comprising:
a second piston which opposes the first piston and which is movably disposed in a substantially parallel relationship to the crankshaft; and
a second member that extends from the second piston and which engages and slidably moves within the second curved groove, such that movement of the second piston in a reciprocating motion causes the second member to move within the second curved groove and rotatably drive the crankshaft.
